(19) United States
(12) Patent Application Publication
(10) Pub. No.: US 2009/0150768 A1
(43) Pub. Date: Jun. 11, 2009

(54) COMPOSITION-BASED APPLICATION USER INTERFACE FRAMEWORK

(75) Inventors: Ju Hee Bae, Seoul (KR); Jonathan P. Munson, Putnam Valley, NY (US); Young Woo Pae, Seoul (KR); Young Ju Tak, Seoul (KR)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 11/953,515

(22) Filed: Dec. 10, 2007

(51) Int. Cl. G06F 17/00

(52) U.S. Cl. 715/248

(57) ABSTRACT

A method and computer readable device for enabling a plurality of telematics services providers to deliver multiple telematics applications to a telematics user device simultaneously by enabling a user interface of each telematics applications to be composed onto a single screen of said telematics device. The method comprises: receiving a content file and a layout file associated with each of the plurality of telematics service by a content push agent, the content file comprising support files including a text file, a graphical file and/or a sound file or the content file comprises a message document including configuration information as to the integration of the support files; storing the support files in a memory cache device by a content manager for storing local copies of the support files for frequent request by a plurality of extendible set of viewers; routing the message document to a viewer compositor which acts as a communication bus between the plurality of extendible set of viewers based upon the message document; and rendering the said plurality of extendible set of viewers simultaneously onto the single screen of the telematics device by a layout manager based upon the layout file.

### BACKGROUND OF THE INVENTION

1. Field of the Invention

The present invention generally relates to the delivery of telematics services and, more particularly, to a novel technique for enabling multiple providers of telematics services to deliver services to users simultaneously by enabling user interfaces to be composed onto a single glanceable screen.

2. Description of the Prior Art

Telematics services refer to automobile systems that combine global positioning satellite (GPS) tracking and other wireless communications for such services as automatic roadside assistance and remote diagnostics. (e.g. General Motors Corp. “OnStar® system”), recovery of stolen vehicles (e.g. “LoJack®”), tracking fleet vehicle locations, providing automatic collision notification, and location-driven driver information services. With the increasing convergence of ubiquitous wireless networks and the Internet, vehicles equipped with Internet-connected telematics devices, have access to an increasing number of Internet-based telematics services and applications from a variety of providers. Telematics device users are now able to choose, for example, navigation services from one provider, traffic updates and congestion maps from another, “buddy tracking” and other social networking services from another, and vehicle care services (e.g., diagnostics) from another. Services such as tourist guides, weather advisories, and location-based information directories are also now available from various providers.

The plethora of new telematics services raise a number of challenges for user-interface technology for the mobile-user context, where screens are small and users have limited and sporadic ability to focus on their displays.

In a conventional (user interface) UI model, each application provides its own user interface. But in an in-vehicle telematics environment, this approach suffices for only a small number of applications. Moreover, in an environment where consumers can choose their telematics services, a user could subscribe to perhaps a dozen telematics services, and use several at the same time. Switching between a dozen or so telematics services would require a vehicle driver to divert his attention from driving the vehicle to switch from one application to the next, which is obviously unacceptable. Hence, what is desirable in a telematics environment is a glanceable telematics display, so as to avoid diverting the vehicle driver's attention from driving the vehicle.

Moreover, the conventional UI model framework does not allow for displaying multiple telematics services at the same time and for providing interaction between multiple telematics services and applications. For example, a tourist's travel experience could be enhanced if he had a telematics device, which could provide a navigation service to provide travel guidance around a city, while receiving restaurant locations on their map, and at the same time the tourist could view the locations of their traveling companions. According to the conventional telematics systems and methods currently available, telematics services are delivered as separate applications and therefore this tourist scenario is not possible in the conventional art as each application renders its own maps, with its own particular features—routes, traffic alerts, restaurant locations, and positions of companions—overlaid on them. Thus, if users are receiving real-time navigation instructions from one service and traffic alerts from another, they cannot easily see if any traffic alerts relate to the routes they are taking. A telematics user cannot easily see if their companions are located next to recommended restaurants. In using the services simultaneously, they are forced to switch back and forth from one application to another. They must manage the viewer of each map separately, and to navigate through the different user interface characteristics of the different applications (e.g., different pan and zoom controls).

Hence, it would be desirable in a telematics environment to provide a telematics display, which could render multiple telematics services at the same time and enable each application or service to interact with one another.

Yet another related problem in the conventional art is that telematics interfaces must be highly responsive whereas drivers are typically engaged in other tasks and do not have time to wait for a display screen to refresh. However, responsiveness is not readily obtainable in telematics devices because their processing power is not as powerful as personal computers. Moreover, cellular wireless networks do not have the low latency and high bandwidth as found in wired networks or wireless LANs. These limitations in the responsiveness of telematics devices have forced mobile-device user-interface technology into two models: a client/server model where an application consists of a device-based client and a server-based backend, and a document-oriented model where the documents are simple and the supported types of user actions are limited. The document-oriented model has significant advantages over the client/server model whereas only the document viewer needs to be implemented for multiple devices, rather than each application's client. Moreover, application maintenance and update is more easily managed in a document-oriented model since there is no client to update for each user. However, the document-oriented model only supports generic forms of application UIs, which results in user interaction with a telematics device being awkward due to the poor rendering content (e.g. simulated buttons not easily selected). Hence, it would be desirable in a telematics environment to provide an ergonomic telematics interface, which is highly responsive to a user's needs to avoid distracting a driver's attention.

Having set forth the limitations of the prior art, it is clear that what is required is a method or system of enabling multiple providers of telematics services to deliver services to users simultaneously by enabling user interfaces to be composed onto a single glanceable screen.

### SUMMARY OF THE INVENTION

It is therefore an object of the present invention to provide a novel technique and method for providing a telematics services framework that enables multiple providers to deliver services to users simultaneously by enabling their user interfaces to be displayed or presented onto a single glanceable screen.

An additional object of the present invention is to provide a document-oriented model that enables rich ergonomic user interfaces by allowing application providers to compose user interfaces from multiple viewers, each supporting a specific form of UI.

An additional object of the present invention is to provide a method for enabling a plurality of telematics services providers to deliver multiple telematics applications to a telematics user device simultaneously by enabling user interfaces of each telematics application to be composed onto a single screen of said telematics device, comprising the steps of: receiving a content file and a layout file associated with each said plurality of telematics services by a content push agent, said content file comprising support files including a text file, a graphical file and/or a sound file or said content file comprises a message document including configuration information as to the integration of said support files; storing said support files in a memory cache device by a content manager for storing local copies of said support files when requested by a plurality of extendible set of viewers; routing said message document to a viewer compositor for accessing said plurality of extendible set of viewers based upon said message document; and rendering each said plurality of extendible set of viewers simultaneously onto said single screen of said telematics device by a layout manager based upon said layout file, wherein each said extendible set of viewers has an independently updateable element per telematics application for composing content from said multiple telematics applications into a single composition in a plurality of window pane and said independently updateable element individually updatable through a plurality of support files referenced in a content file (e.g. the map viewer overlays map features, the ticker viewer scrolls messages in sequence, the dock viewer updates dock icons separately).

Another additional object of the present invention is to provide a plurality of extendible set of viewers comprising: a map viewer for revealing map-based information; a HTML viewer for enabling said telematics applications to send multimedia messages on HTML to said single screen of said telematics device; a dock viewer for presenting an inactive telematics application as a descriptive icon onto said single screen of said telematics device; a ticker viewer for deliver short text-only messages; a sound player for playing sound files on said on said telematics device; an optional plug-in viewer for allowing each said telematics service provider the option of providing a custom viewer; and an optional declarative UI viewer for allowing each said telematics service provider the option of using conventional widgets including buttons, check boxes and text fields.

Another additional objection of the present invention is to provide a viewer compositor element including an embedded HTTP server that receives requests from said plurality of extendible set of viewers and invokes a viewer indicated action.

Another additional objection of the present invention is to provide a layout manager that provides that each said plurality of extendible set of viewer is presented in a glanceable manner so as to avoid distracting a driver.

Yet another additional objection of the present invention is to provide a layout manager which configures said single screen of said telematics device as closing tags, comprising: an id tag for identify the layout of said telematics application; a row tag for indicating a horizontal layout axis; a col tag for indicating a vertical layout axis, wherein said col tag can provide a viewer's name to be displayed in the pane of said viewer if plain text is indicated in the code, and alternatively if a size element is provided, said col tag specifies a width or a height of each pane of a layout of said single screen of said telematics device; a rowspan element for defining the number of rows spanned by a cell; and a colspan element for defining the number of cols spanned by a cell. By providing a layout scheme, the present invention, provides a specification-based layout, eliminating the need for a telematics service provider to provide its own layout manager.

### BRIEF DESCRIPTION OF THE DRAWINGS

The objects, features and advantages of the present invention will become apparent to one skilled in the art, in view of the following detailed description taken in combination with the attached drawings, in which:

FIG. 1 is an illustration overall architecture of the technique for enabling multiple providers of telematics services to deliver services to users simultaneously by enabling user interfaces to be composed onto a single glanceable screen in accordance with the present invention;

FIG. 2 illustrates an the XVC viewer and the data schema of the layout manger, according to a preferred embodiment of the present invention; and

FIG. 3 illustrates an example of a viewer interaction where the Viewer Compositor acts as an interactive proxy between viewers.

### DETAILED DESCRIPTION OF THE PREFERRED EMBODIMENTS

After providing an overview of the present invention's novel document-oriented model for delivery of telematics services to present interactive user interfaces on in-vehicle clients, the architecture and operation of the present invention will be disclosed in reference to the figures.

The present invention discloses a novel document-oriented model for delivery of telematics services to present interactive user interfaces on in-vehicle clients, which are hereafter referred to as “XVC,” the “XVC model” or “XVC client” (eXtensible Viewer Composition). XVC has three primary characteristics: (1) it supports a document-based application model; (2) application user-interfaces are compound documents, each element addressing a different viewer (“viewer composition”); and (3) the user interfaces of multiple applications are composed into a single glanceable user interface on the client (“application composition”) for ease of use and expediency.

XVC's Document-Oriented Application Model

In the XVC model, as exemplified in the present invention, applications execute largely on application servers, and use an in-vehicle client for presenting user interfaces to users. XVC's document-oriented user interface presents telematics services and applications through documents rendered by universal interactive viewers. Hence, XVC introduces a telematics-oriented viewer, and a compound document model that enables applications to compose user interfaces by delivering documents to multiple viewers, each viewer tailored to a different content medium and rendering on a single glanceable user interface.

XVC provides several benefits, such as, consuming fewer resources than a client/server model where each application provides its own client, reducing the number of user interfaces a user has to learn, as each application uses the same set of viewers. Moreover, since individual clients are not required, application development time is reduced by eliminating the requirement for developers to create and maintain their own client. Also, because each viewer's behavior is specified by the schema of the content it must render, XVC can be supported on multiple platforms, such as Java 2 SE, Java 2 ME, and Windows CE. Those skilled in the art would know that other mobile operation systems and platforms could be utilized to implement the present invention and therefore the present invention is not limited to the above platforms and OSs.

### Viewer Composition

As will be clarified below in reference to the figures, the present invention discloses a XVC client, which contains an extensible set of viewers. Telematics applications compose user-interfaces by sending to the XVC client compound documents that contain documents for one or more viewers. The viewers are arranged on the screen according to a layout specification received by the client when the application is subscribed to.

Use of the content-specific viewers reduces application development costs because developers do not have to develop their own clients to support these forms, nor do they need to overlay content-specific interactivity on generic viewers. For example, providers who want to present their content in the form of a ticker do not need to simulate a ticker through an animated GIF or other approximate mechanism; they can simply declare that their text is rendered in the viewer specific to the ticker form. Providers who want to provide map-based content need not provide their own map-viewer clients, nor implement map-specific features like pan and zoom using mechanisms like server-based image refreshes. In this way these viewers also fulfill the requirement for responsive user interfaces because direct support of features like pan and zoom enable the viewer to respond immediately to these actions. Content may contain actions that invoke actions on other viewers. For example, if content in the HTML viewer references content in the map viewer, clicking on the content in the HTML viewer highlights it in the map viewer; and clicking on a map feature in the map viewer loads HTML linked to that feature. Each viewer provides an API that can be invoked by other viewers, enabling applications to combine the capabilities of each in order to provide a richer interactive experience. Hence, the present invention's telematics-oriented viewers are each tailored to different content medium

### Application Composition

In the present invention, according to the novel XVC's application composition model enables multiple applications to share the screen simultaneously. Similar to PC windowing systems, XVC retains a notion of “focus,” but in the XVC case focus does not determine which application receives user input, rather it determines which layout is in use. For example, the XVC client can render a navigation application, which will provide routing features on a map, while at the same time provide an indication of a congested zone from a congestion-alerts service on the map and a real-time detour message in a ticker viewer at the bottom of the screen, while additionally providing location-based advertising service as an HTML advertisement in the same screen.

The above travel scenario can render a glanceable display if a user limits their selection of telematics services to be rendered by the XVC client. In order to deal with the “multitasking” situation, where a user accesses multiple telematics services at the same time, the present invention provides a “Dock viewer.” The Dock viewer provides a technique for solving the conflict between telematics service/application's domination of the focus of the XVC screen. To solve this conflict, the present invention provides a “Dock viewer” which displays a non-focused telematics service or application as “Dock icons in the XVC client that presents a “mini-message.” Users can push the application's Dock icon to bring focus to the application.

Referring now to the figures, the architecture and operation of the present inventions technique for enabling multiple providers of telematics services to deliver services to users simultaneously by enabling user interfaces to be composed onto a single glanceable screen shall be disclosed.

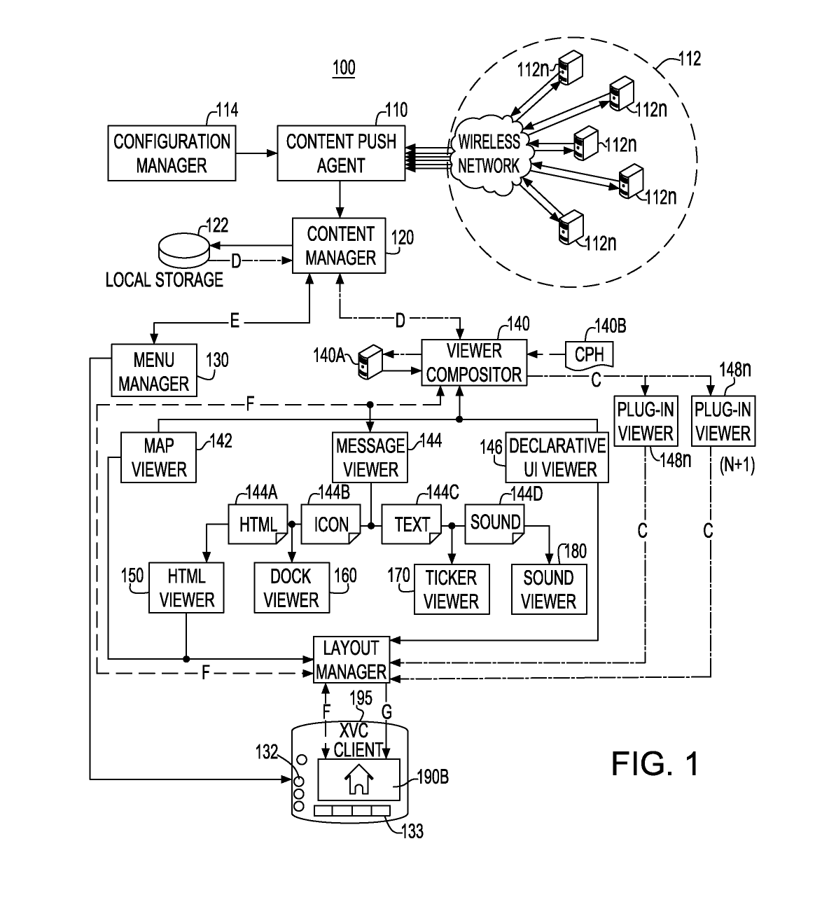

FIG. 1 illustrates the present inventions overall architecture of the technique for enabling multiple providers of telematics services to deliver services to users simultaneously by enabling user interfaces to be composed onto a single glanceable screen 100. As can be seen in FIG. 1 and as will be clarified below, the XVC architecture includes three sets of components, which together render applications from multiple providers of telematics services 112n simultaneously onto a single glanceable screen 190B.

The first sets of XVC components are the application agents, which are the Content Push Agent 110 and Configuration Manager 114 that manages interaction with available telematics services from the Internet-based and other wireless communications networks 112.

The second XVC components are viewer components, which render content and handle user interaction. In FIG. 1, the viewer components are an extendible set of content viewers; the Map Viewer 142, Plug-n Viewer 146, Declarative UI Viewer 148, and Message Viewer 144. The Message Viewer 144 further comprises an HTML Viewer 150, a Dock Viewer 160, a Ticker Viewer 170, and a Sound Player 180.

The third set of XVC components are the application resource management components that handle functions associated with application composition. The application resource management components are the Content Manger 120, Menu Manager 130, Viewer Compositor 140, and the Layout Manger 190A.

As shown in FIG. 1, the present invention provides several viewers for telematics applications:

The Map Viewer 142 reveals map-based information, which is a key component of many telematics applications. As indicated above, the present invention provides an improvement over the prior art by enabling telematics service user to receive information from multiple providers simultaneously (e.g., turn-by-turn driving instructions from one, real-time traffic updates from another, and focused tourist information from still another).

The Map Viewer 142 enables applications to push individual map features to the user, without the requirement to push the entire map. It enables content from multiple providers to be displayed on the same map. With this capability, users can use one application provider for navigation, another for traffic conditions and alerts, and another for tracking the positions of friends and family.

The Map Viewer is based and operates in conjunction with applications written in a map-feature presentation language known as the Map Feature Language, or MFL. MFL is an open language and is based on GML, the Geographic Markup Language, from the Open Geospatial Consortium (www.opengeospatial.org). MFL is described in greater detail below, but a complete description of the MFL specification may be found in IBM technical paper “Map Feature Language (MFL) Specification Version 1.0” 2004, available online at http://domino.watson.ibm.com/library/CyberDig.nsf/1e4115aea78b6e7c85256b360066f0d4/e47c 0e4fdde5559f85257322001b06c7?OpenDocument&Highlight=0,RC24318 and incorporated herein by reference.

MFL is designed to enable commonly portrayed map features to be defined textually, with presentation attributes defined by the content provider. Currently, MFL supports but not necessarily limited to the following kinds of features icons, point-shapes, text, linestrings, polygons, multi-linestrings, multi-polygons, and image tiles. The geometry of each feature is described in geographic coordinate system, using GML. (MFL allows the geometries to be described in any well-known geographic coordinate system). The presentation of each feature is described using presentation attributes such as color, line-width, font and font-size. This integration of geographic coordinates with presentation information is available via the MFL. Alternatively, another embodiment of the present invention could replaced MFL with another semantically similar map rendering language such as, KML, the Google Earth map feature markup language or any other semantically similar map language as known to those skilled in the art. The present invention can comprise a computer program storage device, readable by machine, tangibly embodying a program of instructions executable by a machine (e.g. XML).

The HTML Viewer 150 enables applications to send multimedia messages in HTML 144A to the vehicle. Since messages are HTML, applications may use them to present interactive user interfaces to users. For example, a diagnostics application may send the user a message about a problem that has been detected, and includes in the message a button that will request a service appointment from the user's automobile service center. HTML Viewer 150 is available only for an application running in foreground, and can be utilized to display more detailed information of other contents like Map Viewer 142 or Ticker Viewer 170.

Ticker Viewer 170 enables display of short text-only messages, such as mini news stories or weather information and the “ticker” element sent from a particular telematics application provider 112n only includes text 144C in the ticker message. The Ticker Viewer 170 enables applications to provide short and quick messages in the case that image information is not necessary or an application can't use Map Viewer and HTML Viewer because it is running in background.

Dock Viewer 160, presents dock buttons for all active applications. Pushing the dock button of an application makes it the focus application, which means it determines the screen layout and its menu choices are used for the application menu. The initial icon used for an applications dock button is supplied by the application's static properties. Dock icons 144B are also settable through messages, enabling the application to communicate subtly to the user even when it does not have focus. For example, a navigation application may send the driver an animated icon pointing left to inform him the turning point. Dock icons 144B may be animated.

Sound Player 180 plays sound files like *.wav, *.mp3, and the like audio content files, whose content is alarm sounds or messages in voice. Sound contents 144D are necessary for telematic application because drivers cannot always concentrate their attention on reading text message during driving, and it may be provided along with text message.

Plug-in Viewer 146 is a custom viewer providing the present invention with an executable supplied by an application provider, which implements the ContentViewer interface implemented by all XVC viewers. As opposed to the Map viewer, Message viewer, dock viewer and Declarative UI Viewer, the Plug-in Viewer is not supplied by XVC but rather is a viewer supplied by a telematics application provider (e.g. Netscape plug-in).

It is an extension mechanism provided by XVC for use when an already available viewer does not suit the application's purposes. Integration of a custom viewer in accordance with the present invention will be discussed in greater detail below.

Declarative UI Viewer 148 is available when viewers do not meet the application provider's needs, but when the UI is composed of conventional “widgets” such as buttons, check boxes, and text fields, XVC provides a viewer that renders the applications GUI given in a GUI markup language such as XUL (XML User-interface Language). XUL is a cross-platform language for describing user interfaces of applications. User interaction events received from the viewer are directed to a component supplied by the application.

Hereafter the operation of the present inventions will be clarified with reference to FIGS. 1 to 3. As can be seen in FIG. 1, a plethora of telematics services from of Internet-based and other wireless communications networks 112, from multiple telematics services providers 112n are available to the XVC client 195. For example, the plethora of telematics services providers 112n could be a real time traffic service, navigation applications, a tour guide application or a location-based advertising application. The present invention, as known to those skilled in the art is not limited to the above cited examples and could be any telematics service or Internet-based service capable of rendering on a display screen.

The Content Push Agent (hereafter “CPA”) 110 receives documents and binary content files, a layout file, collectively a “push file,” providing properties associated with each respective application received from a particular telematics services providers 112n as indicated in position ‘A’ in FIG. 1. Each push file received by the CPA 110 is forwarded to the Content Manager 120 and tagged with a “type” identifier, which indicates to the Content Manager how the content should be handled. If the content is a message document, described below, it is routed to the Viewer Compositor 140.

Configuration Manager 114 is provided to interact with the CPA 110 handling of the XVC system settings such as the preferred language on the display 190B, the sound mode (not shown), and the content push agent listening port (not shown). The sound mode turns the sound on/off (e.g. whether a *.wav file contained in a message will be played or not) on the XVC client 195. The listening port opens a TCP/IP socket port in listening mode. In other words, when the XVC client 195 starts it needs to know what port to use, so that the telematics application server knows what IP address and port number is assigned to the XVC client 195. There are numerous methods known by those skilled in the art of providing an agreed upon IP address and port number either can be implemented in a dynamic or static manner.

In addition, the configuration manager 114 is able to map the MIME type to each viewer class and make a link between them so that when a link is invoked, the link will lead to a specified viewer. A property file is provided that maps a MIME type to a Java class name. At startup the properties file is read, the viewers are instantiated, and references to these viewer instances are stored in an internal table that maps MIME types to viewer instances (not shown).

The Content Manager 120 handles telematics user requests for content when interacting with various viewers by retrieving the content from local store 122, if the application has already pushed the content to the client through the Content Push Agent 110. The local store 122 provide a caching function, keeping local copies of frequently requested resources, allowing telematics services providers to significantly reduce their upstream bandwidth usage and cost, while significantly increasing performance. For example, if a real-time navigation service 112n pushes a “turn in 100 meters” message to the XVC client 195, it may elect to first push the map feature indicating the location of the turn, the .wav file with the spoken instruction, and the HTML content displaying text and a graphic for the instruction, to the local store 122 before pushing a content push header 140B that refers to these content files. In other words, as will become clarified below in reference to the content push header 140B, the present invention's XVC model provides that all the support files precede the content push header 140B allowing for a particular telematics services providers 112n to just send GUI updates in instances where the support files are already in the local store 122.

When the XVC client 195 initially interacts with an application from a particular telematics services provider 112n, the application returns an HTTP session identifier. The Content Manager 120 uses this session identifier to establish a session-ID-to-URL mapping. Applications pushing content accompany the content with a relative path for the content plus the HTTP session identifier of the client's session. The Content Manager 120 then caches the content in the local store 122 using the session URL as the key, allowing it to satisfy requests for the content from viewers using the URL.

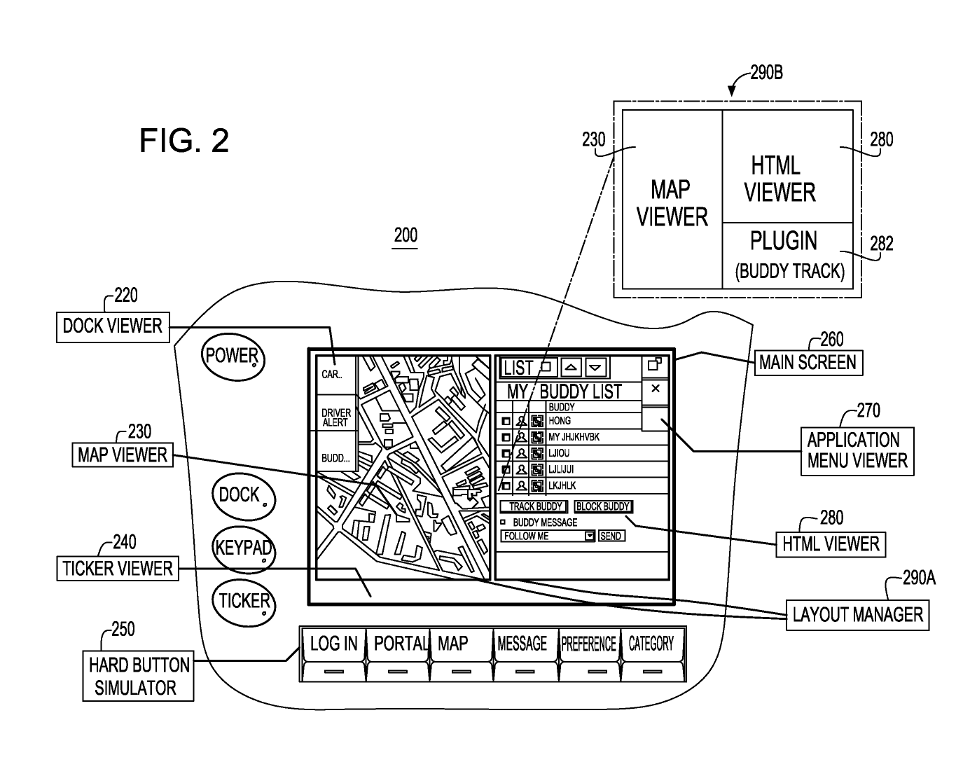

Referring to FIGS. 1 and 2, the Menu Manager 130 by way of the Content Manager 120 in FIG. 1, initially receives set-up information (e.g. language) for display 190B from Configuration Manager 114 through the CPA 110. The Menu Manager 130 also controls the XVC client's 195 one or more sets of simulated hard buttons 132, 133 shown in FIG. 1. As can be seen in FIG. 2, the horizontal Hard Button Simulator 250 includes such QVC control features as Log In, portal, Map, Message, and Preferences, etc.

As can be seen in FIG. 2, the Menu Manager 130 additionally provides an application menu viewer 270 for receiving menu choices from a particular telematics services provider 112n providing a focus application. For example, in FIG. 2, the HTML Viewer 280 presents an illustrative “Buddy Track” application (e.g. in focus) and therefore, the application menu viewer 270 can provide additional menu options such as adding a buddy. The Menu Manager 130 provides the menu of application-specific actions, such as add-buddy (for a buddy-tracking app), or request-new-route (for a navigation app), or save-coupon (for a location-based advertising app). In addition to this function, the Menu Manager 130 may provide a menu of layout alternatives for an application, such as fill-screen-with-map, fill-screen-with-html-window, split-screen-between-map-and-html, or return-to-default-layout.

Referring to FIG. 1, the Layout Manager 190A implements the static aspects of XVC's display screen sharing model by combining configuration inputs from the Viewer Compositor 140 and the extendible set of content viewers, including but not limited to, the Map Viewer 142, HTML Viewer 150, possibility an Plug-In Viewer 146, Declarative UI Viewer 148. This model provides a compromise between the model of desktop windowing systems, where many application windows may share the screen, and that of phone-based windowing systems, where the foreground application completely owns the display. In FIG. 2, Layout Manager 290 enables display of the Map Viewer 230, Ticker 240, HTML Viewer 280, Plug-in Viewer 282 and Dock Viewer 220. Application providers, not the XVC client 200 choose the layout that suits their application.

As can be seen in FIG. 2, the Layout Manager 290A defines a data schema using XML coding to control the layout properties of XVC client 200 main screen 260 such as that shown in FIG. 2 where the Layout Manger 290B is shown as a call out box of that shown in the actual XVC client 200. In coding a viewer screen, the Layout Manager 290B configures a viewer screen 190B (FIG. 1) to open/Close one or more viewers and position the viewers into “window panes” on the main screen by way of “tags” including but not limited to: 1) a “id tag” used to identify the layout, 2) a “row tag” used to indicate a horizontal layout axis, and a “col tag” to indicate a vertical layout axis. The col tag can provide the viewer's name to be displayed in the pane of the viewer if plain text is indicated in the code, whereas viewers are referenced by name, and each viewer is registered in XVC with a distinct name. Alternatively, a size element provided in the col tag specifies width or height of each pane of layout which value can be pixels or percentage. When the value is a percentage value, the value is relative to the size of screen. If the size element is omitted, the size (width or height) is determined by the numbers of panes and the size of screen. A rowspan element defines the number of rows spanned by a cell and the colspan element defines the number of cols spanned by a cell.

As indicated above, the present invention, like windowing systems for personal computers has the notion of “focus application”. In the case of XVC, the focus application is the one whose layout is shown, and whose menu choices are shown in the application menu 270. The effect of focus on the viewers is viewer-dependent. For example, for the Map Viewer 230 it has no meaning. The HTML viewer 280, which can display the content of only one application at a time, shows the content belonging to the focus application. The Ticker Viewer 240 displays the ticker text of the focus application in a more prominent font than the text of the non-focus applications.

The Viewer Compositor 140 plays a central role in the implementation of the present invention's XVC model. As illustrated in FIG. 1, the extendible set of content viewers; Map Viewer 142, HTML Viewer 150, and, in alternative embodiments, the Plug-In Viewer 146, and Declarative UI Viewer 148 do not directly communicate. Rather, the Viewer Compositor 140 acts as communication bus to transport request and response to/from each viewer. Content may include actions that invoke other actions on other viewers to show other types of contents archived in the local file system without connection with server. While the Layout Manager 290 handles the static layout of viewer displays on the screen, the Viewer Compositor 140 handles the dynamic flow of content to the various viewers and the flow of interactions between them.

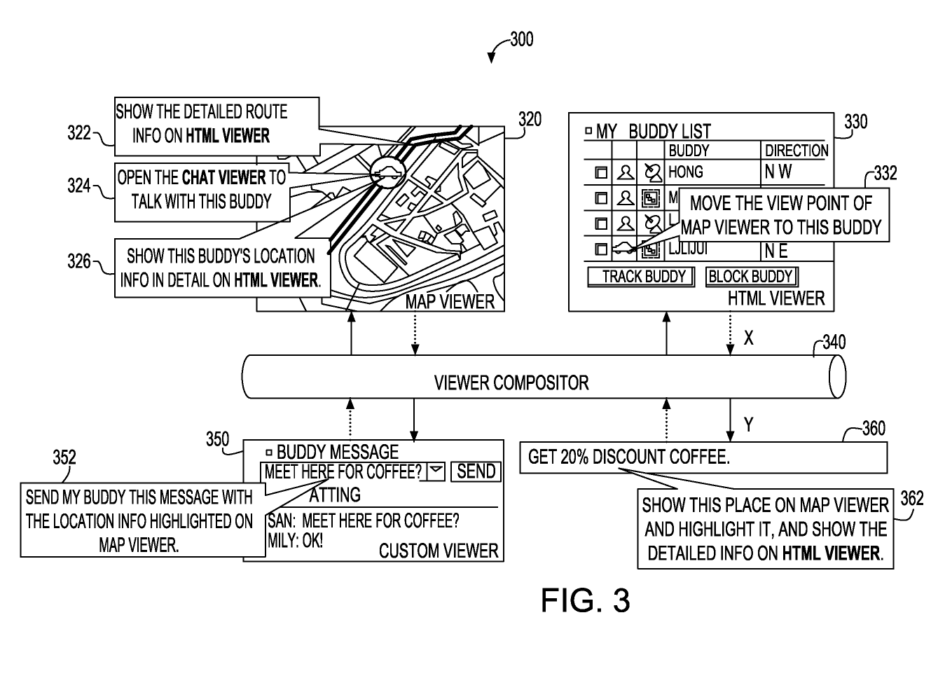

Referring to FIG. 3, there is illustrated an example of viewer interaction where the Viewer Compositor 340 acts as an interactive proxy between each of the viewers. The call out boxes 322, 324, 326, 332, 352 and 362 represent the effects of the actions declared for the indicated content elements. Clicking or tapping on a map feature in the Map Viewer 320 in response may display content linked to that feature displayed in the appropriate viewer for that content. Likewise, the HTML Viewer 330 may request the Map Viewer 320 to move its view to slow the feature linked to the item of content clicked upon or tapped upon. By clicking or tapping on the Ticker Viewer 360, in response, causes the Map Viewer 320 to display the location related to ticker message. Content in the custom viewer like chat window may receive the location information of a place of interest to the viewer.

As indicated in call out box 332, clicking or tapping this buddy icon moves the map by interact with the Viewer Compositor 340 at position X where an HTTP GET requests using query parameters supplied in “invoke” call on a XVC JavaScript library. The Viewer Compositor 340, as described in detail below, interacts with the viewer with an embedded HTTP server, which receives HTTP requests from viewers by way of Viewer Compositor 340. At position Y, a direct method is utilized to fulfill call out box 362 request. Those skilled in the art would know that this operation could also be implemented by a Java-based reflection API.

Asynchronous Viewer interaction is supported within the Viewer Compositor where an Interaction Proxy 140A, as shown in FIG. 1 within the Viewer Compositor, is an embedded HTTP server that receives requests from viewers and invokes the indicated action on the indicated viewer. Viewers supply parameters using HTTP query parameters to the Interaction Proxy 140A. As illustrated in the following two examples, the Interaction Proxy 140A may be invoked through “onclick” attributes on elements in content files, which invoke JavaScript functions that call the Interaction Proxy 140A. The XVC framework provides a library of convenience functions for calling the Interaction Proxy 140A, but it can be invoked in any manner.

Applications supply composite content to the Viewer Compositor 340 using an XML document called the Content Push Header 140B. It contains two sub-elements, header and body within contents element. In the preferred embodiment of the present invention, the Contents header an element that addresses whether the content should be stored locally in local storage 122 or not and which application is associated with the content, and also includes id, title, created date, category, duration and the application provider's information. A Contents body must have at least one child element. The Contents body contains child elements that specify content for one or more of the various viewers. The predefined set includes html, ticker, dock, sound, and map, and can be extended. Each child element of body is simple text or the path for contents, such as multimedia, sound, map feature and graphics.

In addition, the present invention enables application providers to provide the custom viewer with its own UI, and the custom viewer can be controlled by a screen-sharing model like other default viewers.

In embodiments of the invention that employ them, both the Plug-in viewers 148n and Declarative-UI viewers 146 involve binary code supplied by the application provider. Mechanisms and frameworks for downloading this code and dynamically loading it are commonly available. For example OSGi-based frameworks are typically used for these purposes. Plugin viewers are referenced by name in content push header 140B files.

The Plug-in viewer 148n must implement an IContentViewer interface (not shown) defined by XVC. The IContentViewer interface is utilized by the Viewer Compositor 140 and Layout Manager 190A to communication with a Plug-in viewer 148n and is embedded between the Viewer Compositor 140 and Layout Manager 190A and the Plug-in viewers 148n. A representative interface (for a Java embodiment of XVC) is shown below:

public interface IContentViewer extends IContentReceiver {
public void loadContent(String sessionID, String mimeType, String
contentID, byte[ ] content);
public void loadContent(String sessionID, String contentID, Node header,
Node content);
public Control getViewComponent( );
public void layout(int x, int y, int width, int height);
public void setDefaultSize( );
}

The sessionID parameter in the loadcontent( ) methods enables the content viewer to show each application sessions content in its own view if it is unable to compose the content of multiple applications. The getViewComponent( ) method returns a GUI-platform-specific rendering component (an SWT Control in the example above).

Declarative-UI viewers 148 also implement the IContentViewer interface, but use the built-in declarative-UI renderer as their GUI component. A language such as XUL may be used as the UI declaration language. An XVC implementation may make the renderer component available through a library.

As will be readily apparent to those skilled in the art, the present invention or aspects of the invention can be realized in hardware, or as some combination of hardware and software. Any kind of computer/server system(s)—or other apparatus adapted for carrying out the methods described herein—is suited. A typical combination of hardware and software could be a general-purpose computer system with a computer program that, when loaded and executed, carries out methods described herein. Alternatively, a specific use computer, containing specialized hardware for carrying out one or more of the functional tasks of the invention, could be utilized.

The present invention or aspects of the invention can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The present invention can also be embodied as a program on a computer-readable recording medium. Examples of the computer-readable recording medium include but are not limited to Compact Disc Read-Only Memory (CD-ROM), Random-Access Memory (RAM), floppy disks, hard disks, and magneto-optical disks.

While there has been shown and described what is considered to be preferred embodiments of the invention, it will, of course, be understood that various modifications and changes in form or detail could readily be made without departing from the spirit of the invention. It is therefore intended that the scope of the invention not be limited to the exact forms described and illustrated, but should be construed to cover all modifications that may fall within the scope of the appended claims.

What is claimed is:

1. A method of enabling a plurality of services providers to deliver multiple applications to a user device simultaneously by enabling a respective user interface of each application to be composed onto a single screen of said user device, comprising the steps of:
receiving, from the service provider, a plurality of renderable content files and message documents said message document comprising information on the handling of each said renderable content file filed by an extendible set of viewers;
interpreting said message document and controlling said extendible set of viewers according to the content of said message document;
providing communication between said extendible set of viewers; and
rendering, at least two said extendible set of viewers simultaneously onto said single screen of said user device based upon a layout file received from each said service provider,
wherein each viewer of said extendible set of viewers has an independently updateable element per application for composing content from said multiple applications into a single composition in a plurality of window panes and said independently updateable element individually updatable through a plurality of support files referenced in said content file.

2. The method in claim 1, wherein said extendible set of viewers comprise one or more of:
a map viewer for revealing map-based information;
a HTML viewer for enabling said applications to send multimedia messages on HTML to said single screen of said device;
a dock viewer for presenting an inactive application as a descriptive icon onto said single screen of said device;
a ticker viewer for delivering short text-only messages;
a sound player for playing sound files on said on said user device;
an optional plug-in viewer for allowing each said service provider the option of providing a custom viewer; and
an optional declarative UI viewer for allowing each said service provider the option of using conventional widgets including buttons, check boxes and text fields.
